(19) United States
(12) Patent Application Publication
(10) Pub. No.: US 2005/0096027 A1
(43) Pub. Date: May 5, 2005

(54) Communication environment setting method and communication environment setting program

(75) Inventors: Koji Takahashi, Hiratsuka-shi (JP); Yasushi Tsushimi, Hiratsuka-shi (JP); Tomoyasu Hamada, Hiratsuka-shi (JP); Jun Yamane, Hiratsuka-shi (JP); Kentarou Tajima, Hiratsuka-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KOMATSU LTD., Tokyo (JP)

(21) Appl. No.: 10/968,756

(22) Filed: Oct. 19, 2004

(30) Foreign Application Priority Data
Oct. 29, 2003 (JP) 2003-368886

(51) Int. Cl. H04M 3/00

(52) U.S. Cl. 455/418

(57) ABSTRACT

When incorporating a print server (20) in a wireless LAN (1), an attached communication environment setting program is installed in a client terminal (10) and executed. Thereby, an advertisement packet is generated and broadcasted in the wireless LAN (1). In the print server (20), a program preinstalled therein continues attempt of changing channels and modes one by one until the advertisement packet is correctly received, and sets the channel and the communication mode used for the reception as the setting items of the communication environment. Thus, only by installing and executing the communication environment setting program in the client terminal (10), the communication mode and the channel can be set with ease.

### BACKGROUND OF THE INVENTION

1. Field of the Invention

The present invention relates to a communication environment setting method and a communication environment setting program between terminals constituting, for example, a wireless LAN (Local Area Network).

2. Description of Related Art

In recent years, to eliminate a troublesome task of laying a LAN cable and to reduce the cost, wireless LANs are built more often in place of conventional wired LANs. Meanwhile, the increasing number of personal computers (hereafter referred to as PC) and the like are so developed that a wireless LAN adapter can be attached thereto or an internal adapter is built therein. Such wireless LAN is relatively inexpensive as indicated above, and therefore used as a computer network at small offices and home or the like.

In some cases, a new terminal is added and incorporated in an existing wireless LAN. For instance, at home, there may be a case where a newly purchased printer is incorporated in an existing wireless LAN consisting of a plurality of PCs.

In this case, unlike the case where one PC exclusively uses the printer, the plurality of PCs share the printer, and accordingly a print server will be required. Although a commercially available print server is applicable, the communication environment of the print server has to be correctly set in accordance with that of PCs to enable the wireless communication between the print server and the PCs.

The setup of the communication environment includes the setting of SSID (Service Set ID) indicating the group name of the wireless LAN. Generally, the SSID is set by an ordinary user with little knowledge referring to an attached manual, and therefore this task is time consuming and troublesome for the user. To avoid such inconvenience, for example, Japanese Patent Laid-Open Publication No. 8-242245 teaches a method for readily and automatically setting the SSID.

However, the method disclosed in the above publication is applicable for building and adding a new network to existing plural computer networks and so configured to automatically recognize the SSID used for the existing networks on a wireless LAN terminal and allocate an available unused SSID to the new network.

That is, the above publication relates to a method for providing an ID to a new network, but does not relate to the communication environment setting of a new server etc. upon incorporation of the server into an existing network.

Of course, in the newly incorporated print server, the SSID must be set for recognizing the group name of the wireless LAN into which the serve is incorporated. However, what is desired as a more basic point is to make the server recognize which channel or which communication mode is used for communicating with the PCs on the wireless LAN, and to allow an ordinary user to carry out such environment setting with ease.

### SUMMARY OF THE INVENTION

An object of the present invention is to provide a communication environment setting method and a communication environment setting program that can readily set the communication environment of a server incorporated in a wireless LAN.

According to the present invention, a communication environment setting method adapted to set a communication environment corresponding to a client terminal that communicates with a server incorporated in a wireless computer network, includes: in the client terminal, generating an advertisement packet for informing a request of a communication environment setting; broadcasting the advertisement packet; receiving a reply packet for informing a completion of the setting from the server; and confirming a content of the reply packet, in the server, receiving the advertisement packet; changing the communication environment for receiving the advertisement packet; identifying the communication environment in which the advertisement packet is received; setting the communication environment; generating the reply packet; and broadcasting the reply packet.

According to the present invention, a communication environment setting program adapted to set a communication environment corresponding to a client terminal that communicates with a server incorporated in a wireless computer network, makes the client terminal function as: an advertisement packet generating section that generates an advertisement packet for informing a request of a communication environment setting; a broadcasting section that broadcasts the advertisement packet; a reply packet receiving section that receives a reply packet for informing a completion of the setting from the server; and a content confirming section that confirms a content of the reply packet, and also makes the server function as: an advertisement packet receiving section that receives the advertisement packet; a communication environment changing section that changes the communication environment for receiving the advertisement packet; a communication environment identifying section that identifies the communication environment in which the advertisement packet is received; a communication environment setting section that sets the communication environment; a reply packet generating section that generates the reply packet; and a broadcasting section that broadcasts the reply packet.

### BRIEF DESCRIPTION OF THE DRAWINGS

FIG. 1 is a diagram schematically showing a computer network to which a communication environment setting method and a communication environment setting program in accordance with an embodiment of the present invention are applied;

FIG. 2 is a block diagram showing a client terminal;

FIG. 3 is a block diagram showing a server;

FIG. 4 is a flowchart of communication environment setting;

FIG. 5 is a schematic view showing a modification of the present invention.

### DETAILED DESCRIPTION OF PREFERRED EMBODIMENTS

Now, an embodiment of the present invention will be described by referring to the drawings.

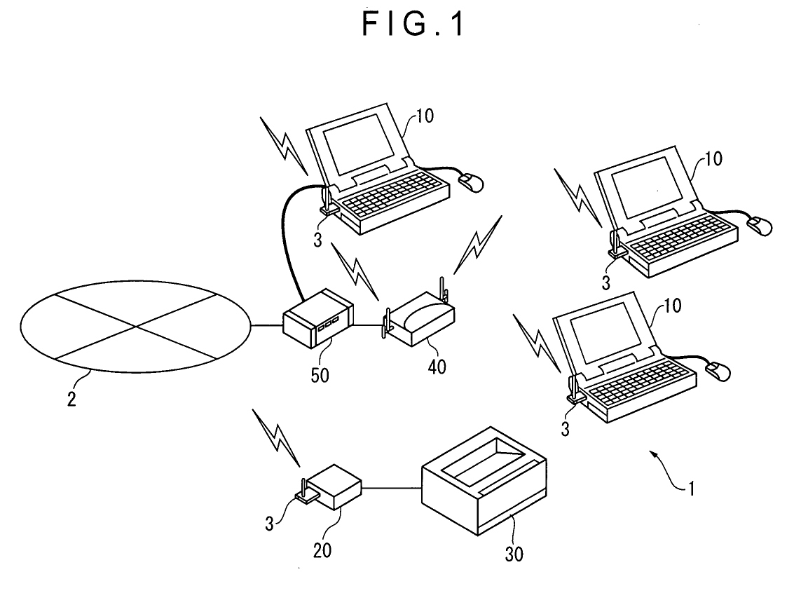

FIG. 1 is a diagram schematically showing a wireless LAN (computer network) 1 to which a communication environment setting method and a communication environment setting program in accordance with this embodiment are applied.

The wireless LAN 1 is a relatively small size network, which might be built at home. The wireless LAN 1 includes a plurality of PCs (three PCs in this embodiment) as client terminals 10, a printer 30 connected to a print server (server) 20 through a cable, a wireless access point 40 enabling wireless communication between each client terminal 10 and the print server 20, and a router 50 connected to the wireless access point 40 through a LAN cable. The wireless LAN 1 is connected to Internet 2 via the router 50.

One of the tree terminal clients 10 is connected to the router 50 thorough the LAN cable for the purpose of configuring the wireless access point 40 and the router 50.

The client terminals 10 and the print server 20 are respectively equipped with wireless LAN adapters 3. While the wireless LAN adapter 3 shown in the drawings is an external device attached to the PC body or the server body, it may be the one already built in those bodies.

While the wireless access point 40 and the router 50 shown in the drawings are separately provided, they may be replaced by a single unit such as a wireless router having the functions of both devices.

This embodiment is based on the assumption that, for example, the printer 30 is newly purchased, and three client terminals 10 share the printer 30 that was not provided when the wireless LAN 1 was initially built. Therefore, the print server 20 is purchased together, and the printer 30 is installed so that the data can be received from the wireless access point 40 via the print server 20. The data transmitted from each client terminal 10 is controlled by the print server 20 for printing it out. The present invention is used at the time of incorporating the newly purchased print server 20 in the wireless LAN 1 so as to automatically set up the initial communication environment of the print server 20, i.e., a communication mode, a chancel and a SSID, for enabling the communication between each client terminal 10 and the print server 20.

Although the wireless LAN 1 uses the TCP/IP for its communication, the wireless LAN 1 does not necessarily have to be connected to the Internet 2 even when this protocol is used. Accordingly, if the wireless LAN 1 is not connected to the Internet 2, the router 50 will not be used. The printer 30, the wireless access point 40 and the router 50, which are elements of the wireless LAN 1, have standard functions that are generally provided for these types of devices. Accordingly, detailed descriptions thereof will be omitted.

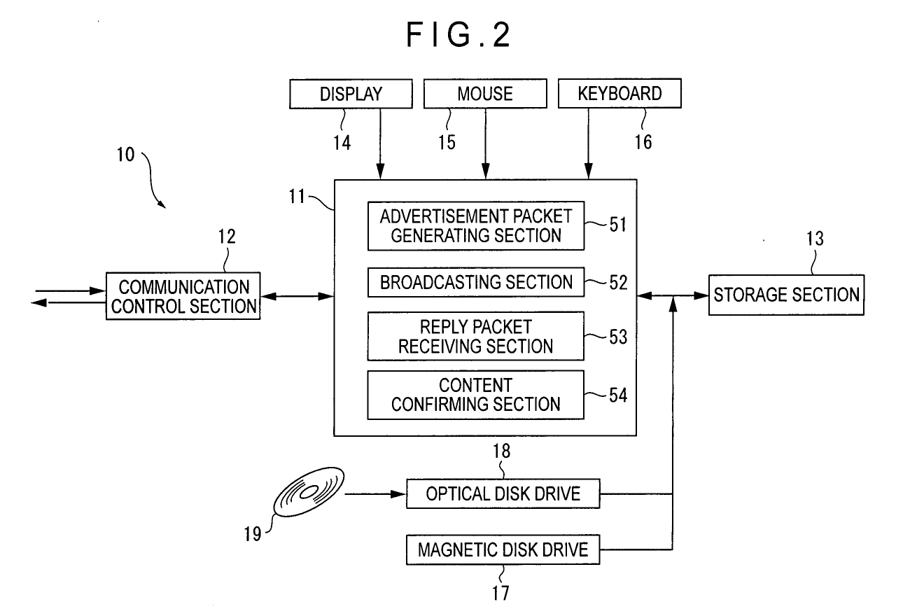

The client terminals 10 are basically general-purpose personal computers. As shown in FIG. 2, each client terminal 10 has an arithmetic processing section 11 for executing various utility programs (application software) that run on an OS (Operating System), a communication control section 12 for controlling data input/output via the wireless LAN 1, a storage section 13 including a magnetic disk, a ROM, a RAM and the like, a display 14, a mouse 15, a keyboard 16, a magnetic disk drive 17, an optical disk drive 18 and the like.

FIG. 2 shows a state that a CD-ROM 19 as a storage medium is inserted into the optical disk drive 18; an utility program (communication environment setting program) stored in the CD-ROM 19 is installed in the storage section 13; and the program is called up from the storage section 13 and executed in the arithmetic processing section 11. That is, FIG. 2 shows a state that, immediately after incorporating the print server 20 to the wireless LAN 1 and turning it on, a user sets up the communication environment using the CD-ROM 19 attached to the print server 20.

The utility program makes the client terminal 10 function as an advertisement packet generating section 51, a broadcasting section 52, a reply packet receiving section 53, and a content confirming section 54.

The advertisement packet generating section 51 generates an advertisement packet when the utility program is started, and sends the packet to the broadcasting section 52. The advertisement packet is a packet for informing the print server 20 that the client terminal 10 is requesting the communication environment setting.

The broadcasting section 52 broadcasts the advertisement packet to all the terminals that can access to the wireless LAN 1 via the wireless access point 40, i.e., to other client terminals 10 and the print server 20.

In this step, the communication mode in the client terminal 10 of the sending end is set to an infrastructure mode so as to send the advertisement packet to the wireless access point 40. In this embodiment using the TCP/IP, the frequency available to the wireless LAN 1 is divided into 14 channels, one of which is used as a predetermined channel for sending the advertisement packet. The data in the advertisement packet carries the SSID of the wireless LAN 1.

The reply packet receiving section 53 receives a reply packet (which will be described later) from a terminal (herein, the print server 20) on the wireless LAN 1, and sends the packet to the content confirming section 54.

The content confirming section 54 confirms that the setting of the channel, the communication mode, and the SSID in the print server 20 are completed based on the content of the reply packet, and ends the utility program.

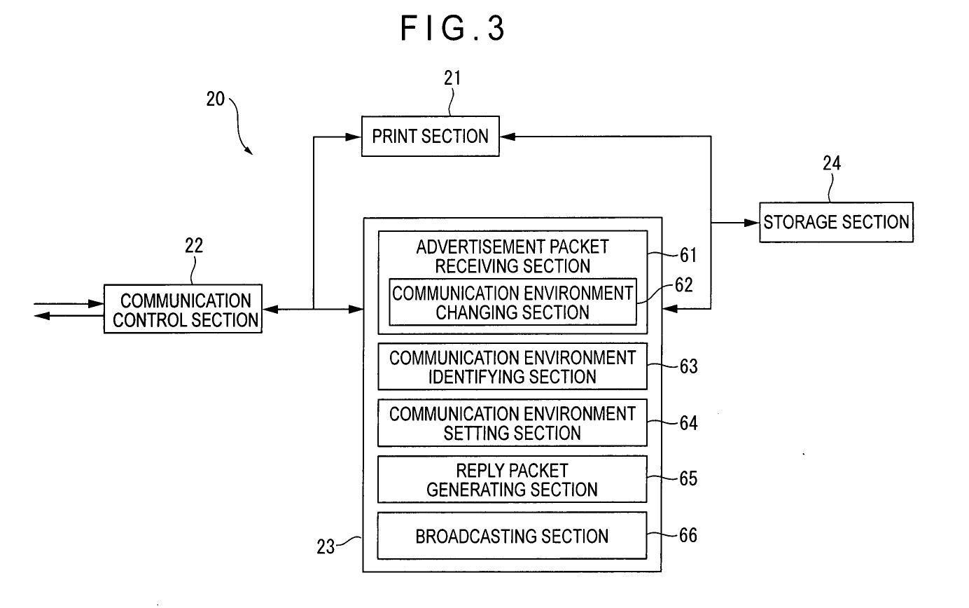

Referring to FIG. 3, the print server 20 has a print section 21 responsible for its original functions as the server, a communication control section 22 for controlling the data input/output via the wireless LAN 1, an environment setting support section 23 for supporting the setup of the communication environment, and a storage section 24 including a ROM or the like. In the storage section 24, an advertisement packet receiving section 61, a communication environment changing section 62, a communication environment identifying section 63, a communication environment setting section 64, a reply packet generating section 65 and a broadcasting section 66 are stored as an environment setting program.

FIG. 3 shows a state that these sections 61 to 66 are called up and executed by the environment setting support section 23.

The advertisement packet receiving section 61 receives the advertisement packet broadcasted in the wireless LAN 1, and sends the packet to the reply packet generating section 65.

Upon receiving the advertisement packet, the communication environment changing section 62, which is one of the functions of the advertisement packet receiving section 61, switches the channels from a channel 1 to 14, tries the communication mode in a pseudo ad-hoc mode for each channel, and switches to a standard ad-hoc mode or the infrastructure mode on a predetermined channel so as to receive the advertisement packet in any one of the channels and communication modes.

The communication environment identifying section 63 identifies the channel and the communication mode used for receiving advertisement packet, and recognizes the SSID carried by the data in the advertisement packet.

The communication environment setting section 64 sets the identified channel, communication mode (the infrastructure mode in this embodiment) and SSID as the setting items of the communication environment. In other words, the section 64 stores them in a setting table or the like in the storage section 24.

The reply packet generating section 65 generates a reply packet for informing that the environment setting is completed in the print server 20 in accordance with the request command of the advertisement packet, and sends the reply packet to the broadcasting section 66.

The broadcasting section 66 broadcasts the reply packet to all the terminals on the wireless LAN 1 via the wireless access point 40, i.e., to all the client terminals 10.

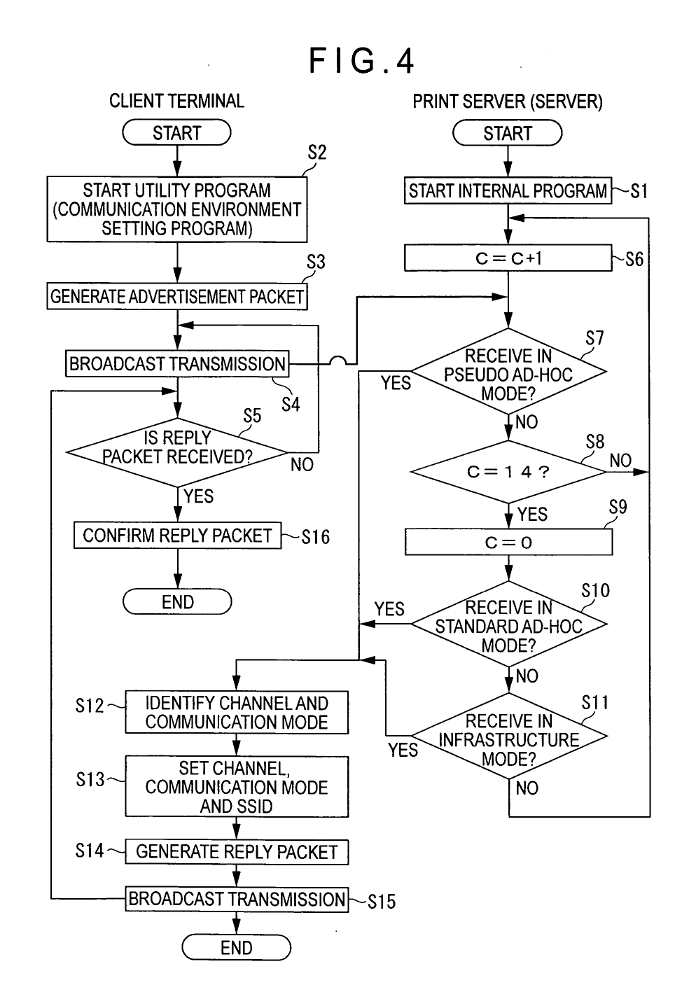

The following description will explain how to set the communication environment in the print server 20 when the print server 20 is newly incorporated in the wireless LAN 1 with reference to the flowchart in FIG. 4.

Step 1 (hereinafter, the word “step” will be abbreviated to “S”): First of all, the print server 20 is set in position and turned on, and then the internal program is started.

S2: An arbitrary client terminal 10 is started up, and the CD-ROM 19 is inserted and started.

S3, S4: In the client terminal 10, the advertisement packet generating section 51 is started to generate the advertisement packet, and the broadcasting section 52 broadcasts the advertisement packet.

S5: The broadcasting of the advertisement packet continues until the reply packet receiving section 53 receives the reply packet from the print server 20. Although not illustrated, the reply packet receiving section 53 is equipped with a timer so that, in the case where the reply packet is not received within a predetermined time period, an error mark or message is displayed on the display 14.

S6: Meanwhile, in the print server 20, the running internal program activates the communication environment changing section 62 of the advertisement packet receiving section 61 to attempt the reception of the advertisement packet using the channel 1 (C=1) firstly.

S7-S9: In other words, the reception is firstly attempted in the pseudo ad-hoc mode. In the pseudo ad-hoc mode, the reception is attempted in the channel 1, and if the reception is unsuccessful, operation returns to S6. The channel is then switched to the channel 2 (C=2) to attempt the reception again. If such attempt is made in the channels 1 to 14 (C=1 to 14) and still unsuccessful in receiving the advertisement packet, the channel is cleared and operation proceeds to S10.

S10: If the advertisement packet cannot be received in the channels 1 to 14 in the pseudo ad-hoc mode, the mode is changed to the standard ad-hoc mode to attempt the reception.

S11: If the packet still cannot be received, the mode is then changed to the infrastructure mode to attempt the reception. If the packet cannot be received with these attempts, operation returns to S6 again to reattempt the reception from the pseudo ad-hoc mode.

Note that the channel switching operation is unnecessary for the standard ad-hoc mode and the infrastructure mode. If the reception continues to be unsuccessful in all channels and the client terminal 10 aborts the transmission of the advertisement packet due to the time-out, the environment setting in the print server 20 is stopped at this point.

S12: The print server 20 according to this embodiment receives the advertisement packet in the infrastructure mode in S11. On receiving the advertisement packet, the communication environment identifying section 63 identifies the channel (only in the case of the pseudo ad-hoc mode) and the communication mode (the infrastructure mode in this embodiment) used for the reception, and recognizes the SSID carried by the advertisement packet.

S13: The communication environment setting section 64 then sets the identified channel, communication mode and SSID as the setting items of the print server 20.

S14: The reply packet generating section 65 generates the reply packet for informing the completion of the communication environment setting, and sends the packet to the broadcasting section 66.

S15: The broadcasting section 66 receives the reply packet and broadcasts the packet into the wireless LAN 1.

S16: When the client terminal 10 monitors the reply packet from the print server 20 and receives the packet in S10, the content confirming section 54 confirms the content of the reply packet, determines that the communication environment setting in the print server 20 is completed, and quits the program to end all the communication environment setting.

According to the above-described embodiment, the following effects can be obtained.

With the use of the communication environment setting program, the advertisement packet is generated in the client terminal 10, and this advertisement packet is broadcasted in the wireless LAN 1. Meanwhile, in the print server 20, the advertisement packet is received with the use of the preinstalled program. In this step, since the print server 20 does not know in which channel and communication mode the advertisement packet is sent, the print server 20 keeps the receiving state while switching the channels and modes one by one. When the advertisement packet is correctly received in a predetermined channel and mode, the channel, the mode and the SSID carried by the advertisement packet are set as the setting items of the communication environment of the print server 20.

Accordingly, the newly purchased print server 20 or printer 30 can be incorporated in the wireless LAN 1 only by installing the utility program in the attached CD-ROM 19 into the client terminals 10 and executing the program. Thus, the communication environment of the print server 20 can be automatically set up, thereby allowing an ordinary user with little knowledge easily carry out the setting operation.

The present invention is not limited to the above specific embodiment, but includes other configurations as long as the object of the present invention can be achieved. The following modifications are also included in the present invention.

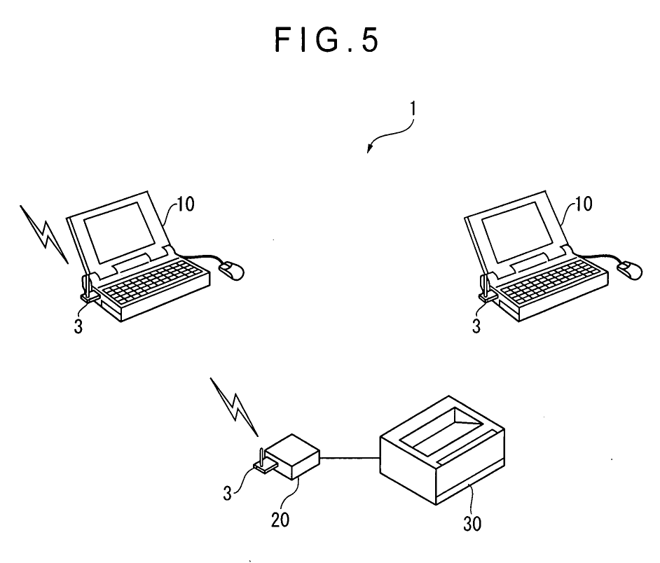

For example, while the client terminals 10 and the print server 20 communicate in the infrastructure mode with the use of the wireless access point 40 in the above embodiment, the present invention is applicable to the communication between an arbitrary client terminal 10 and the print server 20 without the wireless access point 40 as shown in FIG. 5. In such case, the pseudo ad-hoc mode or the standard ad-hoc mode is set in the print server 20.

While the channel, the communication mode and the SSID are listed as the setting items in the above embodiment, WEP (Wired Equivalent Privacy) and the like may be added.

On the other hand, as long as the communication mode and the channel used for the reception can be automatically set by changing at least the communication mode and the channel to receive the advertisement packet, the present invention includes such case where the SSID is set by another method.

Also, the present invention includes such case where either one of the communication mode or the channel is set automatically.

In the above embodiment, the print server 20 is applied as the server according to the present invention. However, the server is not limited thereto, and may be a projector server, a FAX server, a router, a PC having various server functions or the like.

Although the preferred network configuration and the setting method of the communication environment etc. for carrying out the present invention are disclosed above, the present invention is not limited thereto. That is, while the present invention is described with reference to specific a embodiment and drawings thereof, various modifications in shapes, materials, quantity and other configuration details may be made in the disclosed embodiments by those of ordinary skill in the art without departing from the spirit and scope of the invention.

Accordingly, the description limiting the shapes and the materials disclosed above is intended to be illustrative for easier understanding of the present invention and not intended to limit the invention. The present invention therefore includes descriptions of materials without all or a part of the limitation of the shapes and the material.

1. A communication environment setting method adapted to set a communication environment corresponding to a client terminal that communicates with a server incorporated in a wireless computer network, comprising:
in the client terminal,
generating an advertisement packet for informing a request of a communication environment setting;
broadcasting the advertisement packet;
receiving a reply packet for informing a completion of the setting from the server; and
confirming a content of the reply packet,
in the server,
receiving the advertisement packet;
changing the communication environment for receiving the advertisement packet;
identifying the communication environment in which the advertisement packet is received;
setting the communication environment;
generating the reply packet; and
broadcasting the reply packet.

2. A communication environment setting program adapted to set a communication environment corresponding to a client terminal that communicates with a server incorporated in a wireless computer network, wherein,
the client terminal is functioned as:
an advertisement packet generating section that generates an advertisement packet for informing a request of a communication environment setting;
a broadcasting section that broadcasts the advertisement packet;
a reply packet receiving section that receives a reply packet for informing a completion of the setting from the server; and
a content confirming section that confirms a content of the reply packet,
and the server is functioned as:
an advertisement packet receiving section that receives the advertisement packet;
a communication environment changing section that changes the communication environment for receiving the advertisement packet;
a communication environment identifying section that identifies the communication environment in which the advertisement packet is received;
a communication environment setting section that sets the communication environment;
a reply packet generating section that generates the reply packet; and
a broadcasting section that broadcasts the reply packet.
